(19) United States
(12) Patent Application Publication
(10) Pub. No.: US 2023/0327369 A1
(43) Pub. Date: Oct. 12, 2023

(54) WATERPROOF CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Akihiro NISHITANI, Mie (JP); Kenji MAKINO, Mie (JP); Akiko SUZUKI, Mie (JP)

(21) Appl. No.: 18/025,256

(22) PCT Filed: Aug. 3, 2021
(86) PCT No.: PCT/JP2021/028722

§ 371 Date: Mar. 8, 2023

(30) Foreign Application Priority Data
Sep. 23, 2020 (JP) 2020-158381

(51) Int. Cl. H01R 13/52; H01R 13/512; H01R 13/639

(52) U.S. Cl. CPC H01R 13/5219; H01R 13/512; H01R 13/639

(57) ABSTRACT

A waterproof connector is provided with a die-cast case including a box-like case body portion and a tubular portion projecting forward from the case body portion, the die-case case being formed of a cast product made of metal, and a housing made of synthetic resin and accommodated in the die-cast case. An inner peripheral surface of the tubular portion is formed with a sealing surface to be brought into contact with a sealing member of a mating connector. The sealing surface is an unprocessed surface not subjected to polishing after casting. A holding surface for holding the housing in a contact state is formed behind the sealing surface in the die-cast case. The holding surface is a processed surface subjected to polishing to make surface roughness thereof smaller than that of the sealing surface.

### TECHNICAL FIELD

The present disclosure relates to a waterproof connector.

### BACKGROUND

Patent Document 1 discloses an electronic control device in which a printed wiring board and a connector are accommodated in a case made of metal. The case is configured by uniting a case body and a cover, which are formed by press-working a steel plate, and includes a receptacle for accommodating a tubular fitting portion of the connector. A gap between the inner peripheral surface of the receptacle and the outer peripheral surface of the tubular fitting portion is waterproofed by a sealing material.

### PRIOR ART DOCUMENT

### Patent Document

Patent Document 1: JP 2004-214486 A

### SUMMARY OF THE INVENTION

### Problem to be Solved

As a means for reducing the number of components in the above electronic control device, it is considered to make the case a single component formed of a cast product made of aluminum. However, since the cast product made of aluminum is low in dimensional accuracy, there is a concern for rattling between the case and the connector. To prevent the rattling, a contact surface of the case with the connector may be polished and smoothed. However, if a chill layer on the case surface is removed by polishing, corrosion proceeds due to moisture, salt content and the like and the case surface becomes rougher than at the time of casting. Thus, it is not only impossible to realize rattling prevention between the case and the connector, but also difficult to maintain sealability between the case and the connector. As a countermeasure against this, a surface processing may be performed to enhance corrosion resistance after polishing, but manufacturing cost increases if a step of the surface processing is added.

The present disclosure was completed on the basis of the above situation and aims to prevent rattling between a die-cast case and a housing made of synthetic resin and prevent water intrusion into a connected part of the die-cast case and the housing.

### Means to Solve the Problem

The present disclosure is directed to a waterproof connector with a die-cast case including a box-like case body portion and a tubular portion projecting forward from the case body portion, the die-cast case being formed of a cast product made of metal, and a housing made of synthetic resin, the housing being accommodated in the die-cast case, an inner peripheral surface of the tubular portion being formed with a sealing surface to be brought into contact with a sealing member of a mating connector, the sealing surface being an unprocessed surface not subjected to polishing after casting, a holding surface for holding the housing in a contact state being formed behind the sealing surface in the die-cast case, and the holding surface being a processed surface subjected to polishing to make surface roughness thereof smaller than that of the sealing surface.

### Effect of the Invention

According to the present disclosure, it is possible to prevent rattling between a die-cast case and a housing made of synthetic resin and prevent water intrusion into a connected part of the die-cast case and the housing.

### BRIEF DESCRIPTION OF THE DRAWINGS

FIG. 1 is a side view in section of a waterproof connector and a mating connector.

FIG. 2 is a partial enlarged side view in section of the waterproof connector.

FIG. 3 is a partial enlarged side view in section showing a connected state of the waterproof connector and the mating connector.

FIG. 4 is a front view in section of the waterproof connector.

FIG. 5 is a perspective view of a die-cast case viewed obliquely from a lower-rear side.

FIG. 6 is a perspective view of a connector body viewed obliquely from the lower-rear side.

### DETAILED DESCRIPTION TO EXECUTE THE INVENTION

### Description of Embodiments of Present Disclosure

First, embodiments of the present disclosure are listed and described.

(1) The waterproof connector of the present disclosure is provided with a die-cast case including a box-like case body portion and a tubular portion projecting forward from the case body portion, the die-cast case being formed of a cast product made of metal, and a housing made of synthetic resin, the housing being accommodated in the die-cast case, an inner peripheral surface of the tubular portion being formed with a sealing surface to be brought into contact with a sealing member of a mating connector, the sealing surface being an unprocessed surface not subjected to polishing after casting, a holding surface for holding the housing in a contact state being formed behind the sealing surface in the die-cast case, and the holding surface being a processed surface subjected to polishing to make surface roughness thereof smaller than that of the sealing surface. According to this configuration, since the sealing surface not subjected to polishing after casting is covered with a chill layer and free from corrosion due to moisture, salt content and the like, the surface roughness of the sealing surface is not increased due to corrosion. In this way, sufficient sealability is ensured between the sealing surface and the sealing member. With the mating connector fit in the tubular portion, water does not intrude to the holding surface in the die-cast case through a gap between the tubular portion and the mating connector. Thus, the holding surface subjected to polishing is free from corrosion due to moisture, salt content and the like. Since the holding surface is maintained in a state where the surface roughness is small in this way, the occurrence of rattling between the holding surface and the housing can be prevented. According to the present disclosure, it is possible to prevent rattling between the die-cast case and the housing made of synthetic resin and prevent water intrusion into a connected part of the die-cast case and the housing.

(2) Preferably, the holding surface is formed over an entire periphery in a region behind the sealing surface, out of the inner peripheral surface of the tubular portion. According to this configuration, since a part of the housing accommodated in the tubular portion is held over the entire periphery by the holding surface, rattling between the die-cast case and the housing can be more reliably prevented.

(3) Preferably, in (2), inner dimensions of a formation region of the holding surface of the tubular portion are constant from a front end to a rear end of the holding surface. According to this configuration, even if the mounted position of the housing with respect to the holding surface varies in a front-rear direction, an outer peripheral surface of the housing can be held in contact with the holding surface from the front end to the rear end of the holding surface.

(4) Preferably, in (2) or (3), inner dimensions of a formation of the holding surface of the tubular portion are smaller than those of a formation region of the sealing surface of the tubular portion. According to this configuration, the sealing surface can be prevented from being erroneously polished in a step of polishing the holding surface.

(5) Preferably, in (2) to (4), a projection to be squeezed and deformed by being pressed by the holding surface is formed in a region facing the holding surface, out of an outer peripheral surface of the housing. According to this configuration, if the housing expands in the tubular portion due to a difference in linear expansion coefficient between the die-cast case and the housing when temperatures of the die-cast case and the housing increase, the projection is squeezed and deformed. By the squeezing deformation of the projection, the deformation of the entire housing is suppressed.

(6) Preferably, the housing includes a terminal holding portion for holding a terminal fitting penetrating therethrough and a receptacle extending forward from the terminal holding portion and accommodated in the tubular portion, and a front end of the receptacle is located at the same position as that of the terminal fitting or in front of that of the terminal fitting in a front-rear direction. According to this configuration, a front end part of the terminal fitting can be protected from the interference of external matters by being surrounded by the receptacle in a state where the housing is not assembled with the die-cast case.

### Details of Embodiment of Present Disclosure

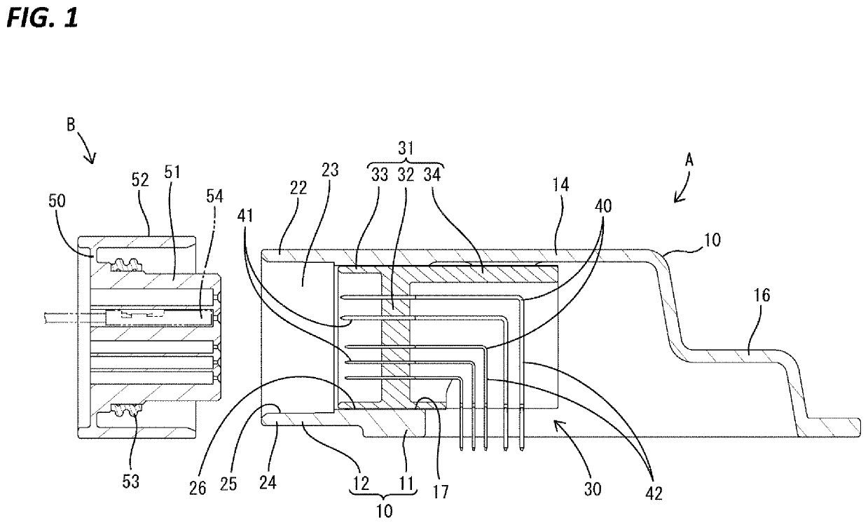

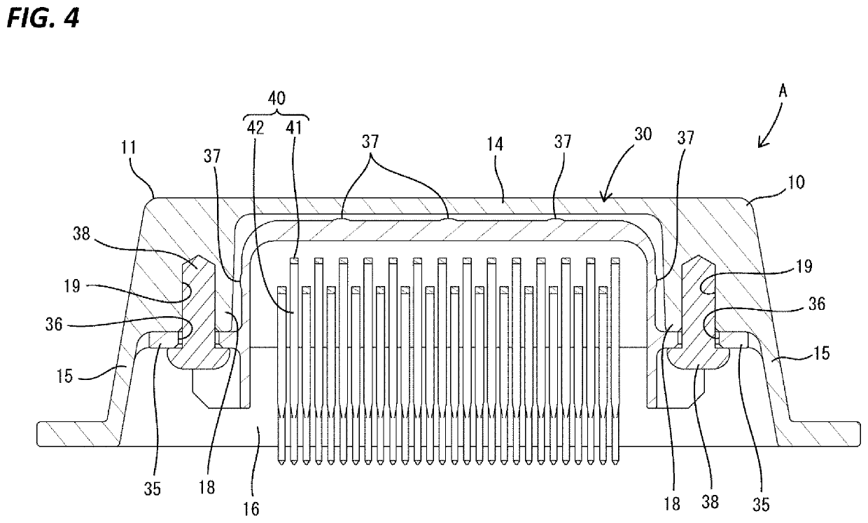

A specific embodiment of a waterproof connector of the present disclosure is described with reference to FIGS. 1 to 6. Note that the present invention is not limited to these illustrations, but is represented by claims and intended to include all changes in the scope of claims and in the meaning and scope of equivalents. In this embodiment, a left side in FIGS. 1 to 3 is defined as a front side concerning a front-rear direction. Upper and lower sides shown in FIGS. 1 to 6 are directly defined as upper and lower sides concerning a vertical direction. Left and right sides shown in FIG. 4 are directly defined as left and right sides concerning a lateral direction.

A waterproof connector A of this embodiment is configured by assembling a die-cast case 10 and a connector body 30 as shown in FIG. 1. The die-cast case 10 is a single component formed of metal such as aluminum, aluminum alloy, zinc alloy, magnesium alloy or copper alloy using a casting die (not shown). The die-cast case 10 includes a box-like case body portion 11 and a tubular portion 12 in the form of a rectangular tube projecting forward from the case body portion 11. The die-cast case 10 is a component which exhibits a shielding function.

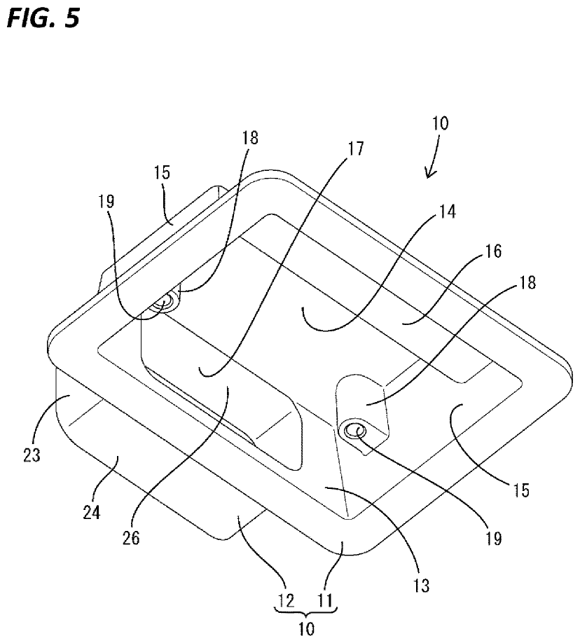

As shown in FIG. 5, the case body portion 11 includes a front plate portion 13, an upper plate portion 14 extending rearward perpendicularly from the upper end edge of the front plate portion 13, a pair of bilaterally symmetrical side plate portions 15 extending downward from both left and right side edges of the upper plate portion 14, and a rear plate portion 16 extending obliquely to a lower-rear side from the rear end edge of the upper plate portion 14. The front plate portion 13 includes a communication port 17 having a laterally long rectangular shape. The front end edges of the both left and right side plate portions 15 are connected perpendicularly to both left and right side edges of the front plate portion 13. The rear plate portion 16 is bent in a stepped manner, and both left and right side edges of the rear plate portion 16 are connected to the rear end edges of the pair of left and right side plate portions 15.

An internal space of the case body portion 11 is open forward of the case body portion 11 at the communication port 17 and open to the outside of the case body portion 11 over the entire region of the lower surface of the case body portion 11. As shown in FIGS. 4 and 5, block-like mounting portions 18 are formed on the inner surfaces of the both left and right side plate portions 15. Each block-like mounting portion 18 is formed with an internally threaded hole 19 having an axis oriented in the vertical direction and open downward.

The tubular portion 12 is formed to project forward from the opening edge of the communication port 17 of the front plate portion 13. The tubular portion 12 includes an upper wall portion 21, a pair of side wall portions 22 extending downward from both left and right side edges of the upper wall portion 21, and a lower wall portion 24 linking the lower end edges of the both left and right side wall portions 22. In a front view of the die-cast case 10, four corners of the tubular portion 12 are bent into a quarter arc shape. An internal space of the tubular portion 12 is open at the front and rear ends of the tubular portion 12, and communicates with the internal space of the case body portion 11 via the communication port 17.

Out of the inner peripheral surface of the tubular portion 12, a front end side region serves as a sealing surface 25 continuous over an entire periphery. A front end part of the sealing surface 25 is open to the outside of the case body portion 11 on the front surface of the tubular portion 12. Inner dimensions (height and width) of a formation region of the sealing surface 25 of the tubular portion 12 gradually increase from the rear end toward the front end of the sealing surface 25. That is, the sealing surface 25 is tapered to be expanded toward the front.

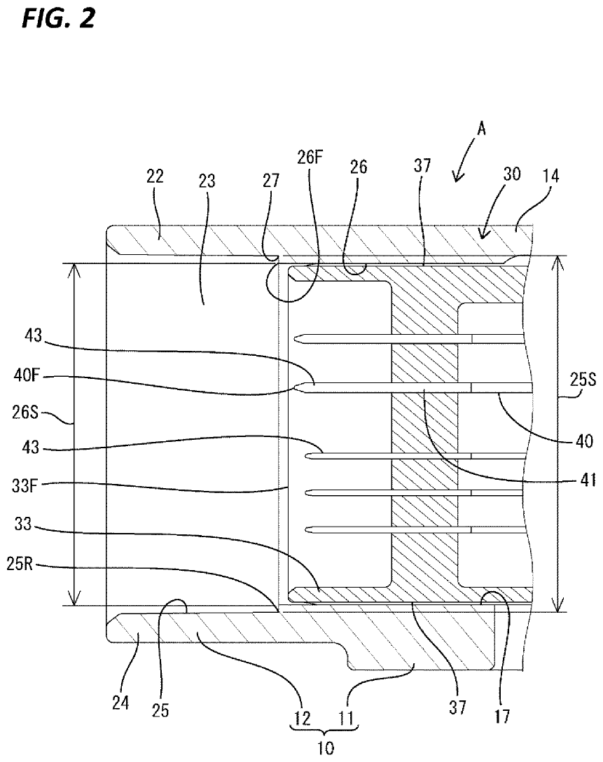

Out of the inner peripheral surface of the tubular portion 12, a rear end side region, i.e. an entire region behind the sealing surface 25, serves as a holding surface 26 continuous over the entire periphery. The holding surface 26 is a processed surface polished to make surface roughness thereof smaller than that of the sealing surface 25 after casting. As shown in FIG. 2, inner dimensions 26S (height and width) of a formation region of the holding surface 26 of the tubular portion 12 are constant from the front end to the rear end of the holding surface 26. The inner dimensions 26S of the formation region of the holding surface 26 of the tubular portion 12 are smaller than minimum inner dimensions 25S of the formation region of the sealing surface 25 of the tubular portion 12. Therefore, a step portion 27 is formed over the entire periphery at a boundary part between a rear end 25R of the sealing surface 25 and a front end 26F of the holding surface 26.

Out of the inner surface of the die-cast case 10, the sealing surface 25 is an unprocessed surface not subjected to polishing after the die-cast case 10 is cast. A chill layer (not shown) produced by rapid cooling is formed on the surface of the die-cast case 10 immediately after casting. This chill layer has such smoothness as to be able to exhibit a sufficient waterproof function. Further, the chill layer is hardly corroded by the adhesion of moisture and salt content and the like.

Out of the inner surface of the die-cast case 10, the holding surface 26 is a processed surface subjected to polishing after the die-cast case 10 is cast. By polishing, the chill layer of the holding surface 26 is removed and the surface roughness of the holding surface 26 is made smaller than that immediately after casting. As described above, a surface of a die-cast product is intrinsically smooth to such an extent to exhibit sufficient sealability. However, in the case of the die-cast case 10 of this embodiment, the surface becomes smoother than immediately after casting by polishing the holding surface 26 and removing the chill layer.

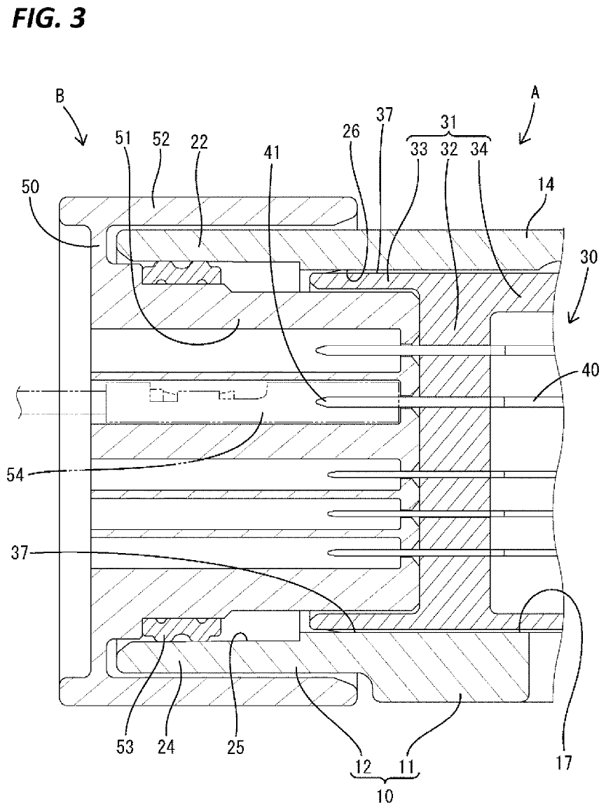

The connector body 30 is provided with a housing 31 made of synthetic resin and a plurality of male terminal fittings 40 mounted in the housing 31. The connector body 30 functions as a board connector to be mounted on a circuit board (not shown). As shown in FIGS. 1 and 3, the housing 31 is a single component including a wall-like terminal holding portion 32, a receptacle 33 in the form of a rectangular tube extending forward from the outer peripheral edge of the terminal holding portion 32 and a box-like protecting portion 34 extending rearward from the outer peripheral edge of the terminal holding portion 32.

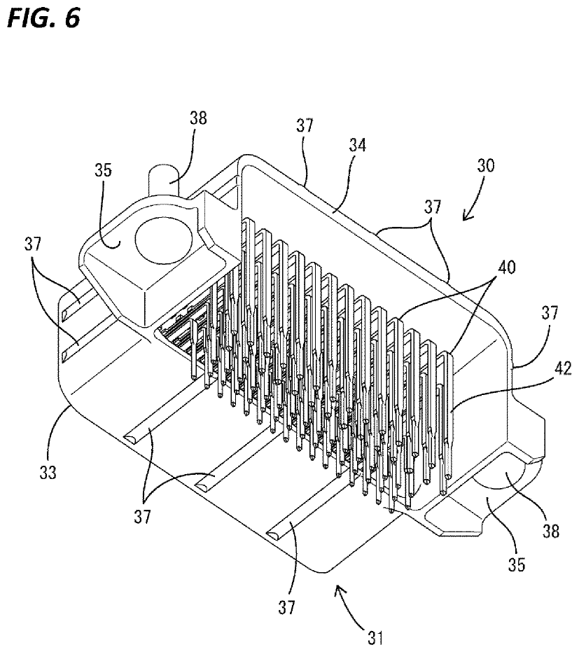

The upper surface of the outer periphery of the receptacle 33 is flush and continuous with that of the outer periphery of the terminal holding portion 32 and that of the outer periphery of the protecting portion 34. The side surfaces of the outer periphery of the receptacle 33 are flush and continuous with those of the outer periphery of the terminal holding portion 32. The lower surface of the outer periphery of the receptacle 33 is flush and continuous with that of the outer periphery of the terminal holding portion 32. As shown in FIGS. 4 and 6, plate-like mounting portions 35 protruding horizontally are formed on both left and right outer side surfaces of the protecting portion 34. The plate-like mounting portion 35 is formed with a mounting hole 36 penetrating through the plate-like mounting portion 35 in the vertical direction.

A plurality of rib-like projections 37 elongated in the front-rear direction are formed on the outer peripheral surface of the housing 31. The projections 37 formed on the upper surface of the housing 31 continuously extend over the upper surface of the outer periphery of the receptacle 33, that of the outer periphery of the terminal holding portion 32 and that of the outer periphery of the protecting portion 34. The projections 37 formed on both left and right side surfaces of the housing 31 continuously extend over the side surfaces of the outer periphery of the receptacle 33 and those of the outer periphery of the terminal holding portion 32. The projections 37 formed on the lower surface of the housing 31 continuously extend over the lower surface of the outer periphery of the receptacle 32 and that of the outer periphery of the terminal holding portion 32.

As shown in FIG. 1, the male terminal fitting 40 is formed by bending a bar-like member into an L shape in a side view. The male terminal fitting 40 includes a penetrating portion 41 penetrating through the terminal holding portion 32 in the front-rear direction and a board connecting portion 42 extending downward perpendicularly from the rear end of the penetrating portion 41. As shown in FIG. 2, a tab 43 projecting further forward than the terminal holding portion 32, out of the penetrating portion 41, is surrounded by the receptacle 32. A front end 40F of the male terminal fitting 40 (tab 43) is arranged at a position slightly behind a front end 33F of the receptacle 33. As shown in FIG. 1, the board connecting portion 42 is accommodated in the protecting portion 34 behind the terminal holding portion 32.

The waterproof connector A is configured by assembling the connector body 30 into the die-cast case 10. In assembling, the connector body 30 is accommodated into the case body portion 11 through an opening in the lower surface of the case body portion 11, and the receptacle 33 and the terminal holding portion 32 of the housing 31 are fit into the tubular portion 12 from the inside of the case body portion 11. At this time, the upper, lower, left and right projections 37 slide in contact with the holding surface 26, whereby the housing 31 (connector body 30) is positioned with respect to the die-cast case 10.

After the receptacle 33 and the terminal holding portion 32 are fit into the tubular portion 12, bolts 38 are passed through the mounting holes 36 of the plate-like mounting portions 35 of the housing 31 from below and externally threaded parts of the bolts 38 are screwed into the internally threaded holes 19 of the die-cast case 10 (see FIG. 4). By tightening the bolts 38, the housing 31 (connector body 30) is fixed to the die-cast case 10. As shown in FIG. 2, with the connector body 30 fixed to the die-cast case 10, the front end 33F of the receptacle 33 is located slightly behind the front end 26F of the holding surface 26 (i.e. rear end 25R of the sealing surface 25). In the above way, the connector body 30 is fixed to the die-cast case 10 and the assembling of the waterproof connector A is completed.

The waterproof connector A of this embodiment is connectable to a mating connector B mounted on an end part of a wiring harness (not shown). As shown in FIGS. 1 and 3, the mating connector B is such that a plurality of female terminal fittings 54 are accommodated in a female housing 50. The female housing 50 includes a terminal accommodating portion 51 for accommodating the female terminal fittings 54 and a tubular fitting portion 52 in the form of a rectangular tube extending forward from the rear end of the outer periphery of the terminal accommodating portion 51 and surrounding the terminal accommodating portion 51. A ring-like sealing member 53 is mounted on the outer periphery of the terminal accommodating portion 51.

In connecting the waterproof connector A and the mating connector B, the terminal accommodating portion 51 of the female housing 50 is inserted into the tubular portion 12 and the tubular fitting portion 52 is externally fit to the tubular portion 12 as shown in FIG. 3. When the waterproof connector A and the mating connector B reach a properly connected state, the male terminal fittings 40 and the female terminal fittings 54 are connected and the sealing member 53 is held in close contact with the sealing surface 25 of the die-cast case 10. A gap between the female housing 50 of the mating connector B and the die-cast case 10 of the waterproof connector A is sealed in a liquid-tight manner by the sealing member 53. Therefore, water intrusion into the die-cast case 10 through a connected part of the waterproof connector A and the mating connector B is prevented.

The waterproof connector A of this embodiment is provided with the die-cast case 10 formed of a cast product made of metal, and the housing 31 made of synthetic resin. The die-cast case 10 includes the box-like case body portion 11 and the tubular portion 12 projecting forward from the case body portion 11. The housing 31 is accommodated in the die-cast case 10. The inner peripheral surface of the tubular portion 12 is formed with the sealing surface 25 to be brought into contact with the sealing member 53 of the mating connector B. The sealing surface 25 is an unprocessed surface not subjected to polishing after casting. The holding surface 26 for holding the housing 31 in a contact state is formed behind the sealing surface 25 in the die-cast case 10. The holding surface 26 is a processed surface subjected to polishing in a state where the die-cast case 10 is cast. By polishing, the surface roughness of the holding surface 26 is made smaller than that of the sealing surface 25.

The sealing surface 25 not subjected to polishing after casting is formed into a surface having a small surface roughness by a molding surface of the casting die. Since the sealing surface 25 is covered with the chill layer and free from corrosion due to moisture, salt content and the like, the surface roughness of the sealing surface 25 is not increased due to corrosion. In this way, sufficient sealability is ensured between the sealing surface 25 and the sealing member 53.

Since sealability is ensured, water does not intrude to the holding surface 26 in the die-cast case 10 through the gap between the tubular portion 12 and the mating connector B with the mating connector B fit in the tubular portion 12. Accordingly, the holding surface 26 arranged on a back side of (behind) the sealing surface 25 in the die-cast case 10 is free from corrosion due to moisture, salt content and the like even if being subjected to polishing. In this way, the holding surface 26 can prevent rattling between the holding surface 26 and the housing 31 since being maintained to have a small surface roughness. According to the waterproof connector A of this embodiment, it is possible to prevent rattling between the die-cast case 10 and the housing 31 made of synthetic resin and prevent water intrusion to the connected part of the die-cast case 10 and the housing 31.

The holding surface 26 is formed continuously over the entire periphery in the region behind the sealing surface 25, out of the inner peripheral surface of the tubular portion 12. Since parts (receptacle 33 and terminal holding portion 32) of the housing 31 accommodated in the tubular portion 12 are held over the entire periphery by the holding surface 26, rattling between the die-cast case 10 and the housing 31 can be more reliably prevented.

The inner dimensions 26S of the formation region of the holding surface 26 of the tubular portion 12 are constant from the front end to the rear end of the holding surface 26. In this way, even if the mounted position of the housing 31 with respect to the holding surface 26 varies in the front-rear direction, the outer peripheral surface of the housing 31 can be reliably held in contact with the holding surface 26 from the front end to the rear end of the holding surface 26. The inner dimensions 26S of the formation region of the holding surface 26 of the tubular portion 12 are smaller than the minimum dimensions 25S of the formation region of the sealing surface 25 of the tubular portion 12. According to this configuration, the sealing surface 25 can be prevented from being erroneously polished in a step of polishing the holding surface 26.

The projections 37 to be squeezed and deformed by being pressed by the holding surface 26 are formed in a region facing the holding surface 26, out of the outer peripheral surface of the housing 31. According to this configuration, if the housing 31 expands in the tubular portion 12 due to a difference in linear expansion coefficient between the die-cast case 10 and the housing 31 when the temperatures of the die-cast case 10 and the housing 31 increase, the projections 37 are squeezed and deformed. By the squeezing deformation of the projections 37, the deformation of the entire housing 31 is suppressed and a stress generated in the housing 31 is reduced.

The housing 31 includes the terminal holding portion 32 for holding the male terminal fittings 40 penetrating therethrough and the receptacle 33 extending forward from the terminal holding portion 32 and accommodated in the tubular portion 12. The front end 33F of the receptacle 33 is located at the same position as the front ends 40F of the male terminal fittings 40 or in front of the front ends 40F of the male terminal fittings 40. According to this configuration, front end parts (tabs 43) of the male terminal fittings 40 can be protected from the interference of external matters by being surrounded by the receptacle 33 in a state where the housing 31 is not assembled with the die-cast case 10.

### Other Embodiments

The present invention is not limited to the above described and illustrated embodiment, but is represented by claims. The present invention is intended to include all changes in the scope of claims and in the meaning and scope of equivalents and also include the following embodiments.

Although only the tubular portion is formed with the holding surface in the above embodiment, the holding surface may be formed in both the tubular portion and the case body portion or may be formed only in the case body portion.

Although the inner dimensions of the formation region of the holding surface of the tubular portion are constant from the front end to the rear end of the holding surface in the above embodiment, the inner dimensions of the formation region of the holding surface of the tubular portion may change to increase or decrease from the front end to the rear end of the holding surface.

Although the inner dimensions of the formation region of the holding surface of the tubular portion are smaller than those of the formation region of the sealing surface of the tubular portion in the above embodiment, the inner dimensions of the formation region of the holding surface of the tubular portion may be equal to or smaller than those of the formation region of the sealing surface of the tubular portion.

Although the projections to be squeezed and deformed by being pressed by the holding surface are formed in the region facing the holding surface, out of the outer peripheral surface of the housing, in the above embodiment, the housing may not be formed with any projection on the outer peripheral surface.

Although the front ends of the terminal fittings are located slightly behind the front end of the receptacle in the above embodiment, the front ends of the terminal fittings and the front ends of the terminal fittings may be at the same position in the front-rear direction.

### LIST OF REFERENCE NUMERALS

A . . . waterproof connector
B . . . mating connector
10 . . . die-cast case
11 . . . case body portion
12 . . . tubular portion
13 . . . front plate portion
14 . . . upper plate portion
15 . . . side plate portion
16 . . . rear plate portion
17 . . . communication port
18 . . . block-like mounting portion
19 . . . internally threaded hole
21 . . . upper wall portion
22 . . . side wall portion
24 . . . lower wall portion
25 . . . sealing surface
25R rear end of sealing surface
25S . . . minimum dimension of formation region of sealing surface of tubular portion
26 . . . holding surface
26F . . . front end of holding surface
26S . . . inner dimension of formation region of holding surface of tubular portion
27 . . . step portion
30 . . . connector body
31 . . . housing
32 . . . terminal holding portion
33 . . . receptacle
33F . . . front end of receptacle
34 . . . protecting portion
35 . . . plate-like mounting portion
36 . . . mounting hole
37 . . . projection
38 . . . bolt
40 . . . male terminal fitting (terminal fitting)
40F . . . front end of male terminal fitting
41 . . . penetrating portion
42 . . . board connecting portion
43 . . . tab
50 . . . female housing
51 . . . terminal accommodating portion
52 . . . tubular fitting portion
53 . . . sealing member
54 . . . female terminal fitting

1. A waterproof connector, comprising:
a die-cast case including a box-like case body portion and a tubular portion projecting forward from the case body portion, the die-cast case being formed of a cast product made of metal; and
a housing made of synthetic resin, the housing being accommodated in the die-cast case,
an inner peripheral surface of the tubular portion being formed with a sealing surface to be brought into contact with a sealing member of a mating connector,
the sealing surface being an unprocessed surface not subjected to polishing after casting,
a holding surface for holding the housing in a contact state being formed behind the sealing surface in the die-cast case, and
the holding surface being a processed surface subjected to polishing to make surface roughness thereof smaller than that of the sealing surface.

2. The waterproof connector of claim 1, wherein the holding surface is formed over an entire periphery in a region behind the sealing surface, out of the inner peripheral surface of the tubular portion.

3. The waterproof connector of claim 2, wherein inner dimensions of a formation region of the holding surface of the tubular portion are constant from a front end to a rear end of the holding surface.

4. The waterproof connector of claim 2, wherein inner dimensions of a formation of the holding surface of the tubular portion are smaller than those of a formation region of the sealing surface of the tubular portion.

5. The waterproof connector of claim 2, wherein a projection to be squeezed and deformed by being pressed by the holding surface is formed in a region facing the holding surface, out of an outer peripheral surface of the housing.

6. The waterproof connector of claim 1, wherein:
the housing includes a terminal holding portion for holding a terminal fitting penetrating therethrough and a receptacle extending forward from the terminal holding portion and accommodated in the tubular portion, and
a front end of the receptacle is located at the same position as that of the terminal fitting or in front of that of the terminal fitting in a front-rear direction.
